(19) United States
(12) Patent Application Publication
(10) Pub. No.: US 2015/0260042 A1
(43) Pub. Date: Sep. 17, 2015

(54) Axial Flow Machine

(71) Applicants: Noriyo Nishijima, Tokyo (JP); Akira Endo, Tokyo (JP); Katsutoshi Kobayashi, Tokyo (JP); Kazuyuki Yamaguchi, Tokyo (JP)

(72) Inventors: Noriyo Nishijima, Tokyo (JP); Akira Endo, Tokyo (JP); Katsutoshi Kobayashi, Tokyo (JP); Kazuyuki Yamaguchi, Tokyo (JP)

(73) Assignee: Mitsubishi Hitachi Power Systems, Ltd., Kanagawa (JP)

(21) Appl. No.: 14/413,725

(22) PCT Filed: Jul. 11, 2012
(86) PCT No.: PCT/JP2012/067748

§ 371 Date: May 29, 2015

(51) Int. Cl. F01D 1/02; F01D 5/02; F01D 11/08; F01D 9/04; F01D 25/24; F01D 11/02; F01D 1/04; F01D 5/12

(52) U.S. Cl. CPC F01D 1/023; F01D 1/04; F01D 5/021; F01D 5/12; F01D 9/041; F01D 25/24; F01D 11/02; F01D 11/08; F05D 2220/30; F05D 2240/12; F05D 2240/24

(57) ABSTRACT

The invention provides an axial flow machine that effectively reduces the unstable hydrodynamic force induced by leakage flow and thereby prevents unstable vibrations.

A steam turbine comprises: a ring-shaped cover 6 connected to the outer circumferential side of a rotor blade row 4; and a ring-shaped concave section 12 provided on an inner circumferential surface 8 of a casing 1 for housing the cover 6. A narrow passage 15 is formed between an outer circumferential surface 13 of the cover 6 and a bottom surface 14 of the concave section 12. A narrow inflow passage 18 is formed between an upstream lateral surface 16 of the cover 6 and an upstream lateral surface 17 of the concave section 12. A narrow outflow passage 21 is formed between a downstream lateral surface 19 of the cover 6 and a downstream lateral surface 20 of the concave section 12. Between the narrow inflow passage 18 and the narrow passage 15 lies an expanded inflow passage 22. The expanded inflow passage 22 has a substantially uniform structure in a circumferential direction and is formed such that it is located on the more outer circumferential side than the bottom surface 20 of the concave section 12 and such that it is located upstream side in terms of the rotor's axial direction with respect to the upstream lateral surface 17 of the concave section 12.

### TECHNICAL FIELD

The present invention relates to axial flow machines such as axial flow turbines and the like. The invention relates particularly to an axial flow machine comprising an outer circumferential cover attached to a row of rotor blades and a concave section provided on the casing for housing the cover.

### BACKGROUND ART

Examples of axial flow machines include axial flow turbines such as steam turbines and gas turbines. A typical axial flow turbine comprises the following components: a casing; a rotor rotatably provided within the casing; at least one row of stator vanes provided on the inner circumferential side of the casing; and at least one row of rotor blades provided on the outer circumferential side of the rotor and located axially downstream of the stator vane row. A working fluid (e.g., steam or gas) flows through the stator vane row and then through the rotor blade row, whereby the internal energy of the working fluid is converted into the rotational energy of the rotor. In other words, the working fluid acts on the rotor blades to rotate the rotor.

In some axial flow turbines, a ring-shaped cover (a shroud) is connected to the outer circumferential tip of a rotor blade row, and a ring-shaped concave section is provided on the inner circumferential surface of the casing so as to house the cover. In such a turbine structure, a narrow passage is formed between the outer circumferential surface of the cover and the bottom surface of the concave section, and a narrow inflow passage is formed between the upstream lateral surface of the cover and the upstream lateral surface of the concave section. Also, a narrow outflow passage is formed between the downstream lateral surface of the cover and the downstream lateral surface of the concave section. In such a turbine, while most of the working fluid flows through the main passage to act on the rotor blades, part of it drifts away from the main passage and instead flows through the narrow inflow passage, the narrow passage, and the narrow outflow passage in the stated order. Thus, the escaping fluid may fail to act on the turbine blades and to contribute to the rotation of the rotor. To prevent such fluid leakage and thereby improve the turbine efficiency, a labyrinth seal is often provided in the narrow passage.

However, a limitation is placed on the seal space of the labyrinth seal (i.e., the distance between fins and the surfaces facing them) to cope with the deformation or displacement of components due to thermal expansion or thrust loads. Thus, even if a labyrinth seal is provided in the narrow passage, fluid leakage from the main passage to the narrow passage is still likely to occur, which in turn causes unstable vibrations. The hydrodynamic force components causing such unstable vibrations are now described with reference to FIG. 10.

FIG. 10 is a radial cross section illustrating a narrow passage 104 formed between an outer circumferential surface 101 of a rotor 100 (corresponding to the outer circumferential surface of the foregoing cover) and an inner circumferential surface 103 of a stator 102 (corresponding to the bottom surface of the forgoing concave section). As illustrated in FIG. 10, the rotor 100 is eccentric with respect to the stator 102 due to the manufacturing tolerance, gravity, or vibrations resulting from rotation and lies at the eccentric position represented by the solid line, not at the concentric position represented by the dotted line. Thus, the width H of the narrow passage 104 varies depending on circumferential positions. Inside the narrow passage 104 are a leakage flow from the main passage (i.e., an axial flow) and a swirl flow (i.e., a circumferential flow) resulting from the rotation of the rotor 100 as illustrated by the arrow E. Because of the deviations of the width H of the narrow passage 104 and the swirl flow, a circumferentially non-uniform pressure distribution P is generated in the narrow passage 102. The force of this pressure distribution P that acts on the rotor 100 can be broken down into a force Fx in the direction opposite to the eccentric direction (i.e., the upward force in FIG. 10) and a force Fy in a direction perpendicular to the eccentric direction (i.e., the rightward force in FIG. 10). The force Fy is hereinafter referred to as the unstable hydrodynamic force. The unstable hydrodynamic force Fy causes the rotor 100 to oscillate, and when the unstable hydrodynamic force Fy is greater than the damping force of the rotor 100, unstable vibrations of the rotor 100 are generated. Especially in an axial flow turbine, the swirl flow components of the working fluid increase at the stator vane rows, and because part of the fluid having these increased swirl flow components flows into the narrow passage, the unstable hydrodynamic force Fy becomes large.

Patent Document 1 discloses a method for reducing such swirl flow components of the working fluid entering the narrow passage, which have a significant influence on the unstable hydrodynamic force. In the method disclosed therein, circumferentially-spaced guide vanes or grooves are provided on an upstream lateral surface of the concave section constituting the narrow inflow passage (i.e., on a lateral surface of the diaphragm).

### PRIOR ART DOCUMENTS

### Patent Document

Patent Document 1: JP-2006-104952-A

### SUMMARY OF THE INVENTION

### Problems to be Solved by the Invention

However, the method of Patent Document 1 has drawbacks as discussed below. In the method, for the purpose of reducing the swirl flow components of the working fluid entering the narrow passage, circumferentially-spaced guide vanes or grooves are provided on an upstream lateral surface of the concave section constituting the narrow inflow passage. Thus, a sufficient consideration needs to be given to the arrangement, shape, and number of the guide vanes or grooves. Otherwise, the swirl flow components of the working fluid entering the narrow passage cannot be reduced sufficiently, and the unstable hydrodynamic force cannot be reduced effectively either. For instance, when the pressure increases by the swirl flow components being reduced at the guide vanes, the flow of the working fluid to the guide vanes is suppressed, and the working fluid may avoid the guide vanes and flow into the narrow passage. In such a case, the swirl flow components cannot be reduced sufficiently, and the unstable hydrodynamic force cannot be reduced effectively either. In addition, since the guide vanes or grooves are spaced in a circumferential direction, the flow of the working fluid may be disturbed depending on their arrangement or shape, which increases the unstable hydrodynamic force rather than reducing it. Moreover, a sufficient reduction of the swirl flow components requires a large number of guide vanes, resulting in a complicated turbine structure.

An object of the present invention is thus to provide an axial flow machine that effectively reduces the unstable hydrodynamic force induced by leakage flow and thereby prevents unstable vibrations.

### Means for Solving the Problem

To achieve the above object, the present invention provides an axial flow machine comprising: a casing; a rotor rotatably provided within the casing; a stator vane row provided on the inner circumferential side of the casing; a rotor blade row provided on the outer circumferential side of the rotor and located downstream side in terms of the rotor's axial direction with respect to the stator vane row; a ring-shaped cover connected to the outer circumferential side of the rotor blade row; a ring-shaped concave section provided on an inner circumferential surface of the casing for housing the cover; a narrow passage formed between an outer circumferential surface of the cover and a bottom surface of the concave section, the narrow passage having a labyrinth seal disposed therein; a narrow inflow passage formed between an upstream lateral surface of the cover and an upstream lateral surface of the concave section; and a narrow outflow passage formed between a downstream lateral surface of the cover and a downstream lateral surface of the concave section, wherein the axial flow machine further comprises an expanded inflow passage formed between the narrow inflow passage and the narrow passage, and wherein the expanded inflow passage is configured to: have a substantially uniform structure in a circumferential direction; be located on the more outer circumferential side than the bottom surface of the concave section constituting the narrow passage; and be located upstream side in terms of the rotor's axial direction with respect to the upstream lateral surface of the concave section constituting the narrow inflow passage.

We, the present inventors, have found when the rotor becomes eccentric with respect to the casing and the width of the narrow passage varies depending on circumferential positions, the unstable hydrodynamic force can be reduced effectively by producing a deviation in the circumferential inflow distribution of the fluid entering the narrow passage in a manner proportional to the deviations of the width of the narrow passage. The present invention is based on the above findings, and an expanded inflow passage is thus provided between the narrow inflow passage and the narrow passage. This expanded inflow passage has a substantially uniform structure in a circumferential direction and is formed such that it is located on the more outer circumferential side than the bottom surface of the concave section constituting the narrow passage and such that it is located axially upstream of the upstream lateral surface of the concave section constituting the narrow inflow passage. With the expanded inflow passage, the virtual passage length upstream of the narrow passage can be extended compared with a case in which the expanded inflow passage is not present. Because of this effect, the fluid is influenced by the deviations of the width of the narrow passage (i.e., the deviations of flow resistance), which in turn produces a deviation in the flow rate distribution of the fluid entering the narrow passage. Accordingly, the unstable hydrodynamic force can be reduced effectively, and unstable vibrations can be prevented as well.

### Effects of the Invention

In accordance with the present invention, the unstable hydrodynamic force induced by leakage flow can be reduced effectively, and unstable vibrations can be prevented as well.

### BRIEF DESCRIPTION OF THE DRAWINGS

FIG. 1 is an axial cross section illustrating part of the structure of a steam turbine according to Embodiment 1 of the invention;

FIG. 2 is an enlarged view of the section II of FIG. 1, illustrating the detailed structure of a concave section provided on the casing;

FIG. 3 is a radial cross section of a narrow passage model used for a fluid analysis in the present invention;

FIG. 4 is a graph illustrating the results of the fluid analysis (i.e., the relation between the inflow unevenness rate and the unstable hydrodynamic force) in the present invention;

FIG. 5 is an enlarged cross section illustrating a concave section provided on the casing of a conventional-art steam turbine in which an expanded inflow passage is not provided;

FIG. 6 is a graph illustrating the advantageous effects of Embodiment 1 (i.e., showing the inflow unevenness rate and unstable hydrodynamic force at a narrow passage, which were obtained from a fluid analysis using a model with an expanded inflow passage and a model without it);

FIG. 7 is an enlarged cross section illustrating a concave section provided on the casing of a steam turbine according to Embodiment 2;

FIG. 8 is an enlarged cross section illustrating a concave section provided on the casing of a steam turbine according to Embodiment 3;

FIG. 9 is a perspective view illustrating the whole structure of a bypass member and support members according to Embodiment 3; and

FIG. 10 is a radial cross section showing a narrow passage within a casing to explain the hydrodynamic force components causing unstable vibrations.

### MODES FOR CARRYING OUT THE INVENTION

Embodiments of the present invention will now be described with reference to the accompanying drawings. The embodiments that follow illustrate examples in which the invention is applied to a steam turbine.

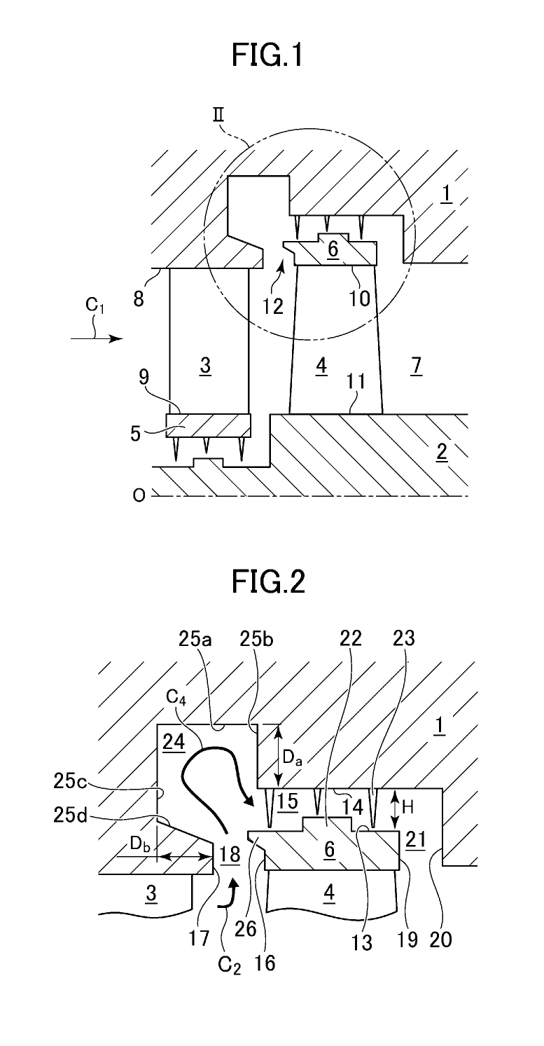

FIG. 1 is an axial cross section illustrating part of the structure of a steam turbine (i.e., stage structure) according to Embodiment 1 of the invention. FIG. 2 is an enlarged view of the section II of FIG. 1, illustrating the detailed structure of a concave section provided on the casing.

As illustrated in FIGS. 1 and 2, the steam turbine comprises a substantially cylinder-shaped casing 1 (stator) and a rotor 2 (rotary shaft) that rotates within the casing 1. A stator vane row 3 is provided on the inner circumferential side of the casing 1 such that multiple stator vanes are arranged in a circumferential direction, and a rotor blade row 4 is provided on the outer circumferential side of the rotor 2 such that multiple rotor blades are arranged in a circumferential direction. The stator vane row 3 has a ring-shaped endwall 5 connected to its inner circumferential side (i.e., the endwall 5 is connected to the distal ends of the respective stator vanes) while the rotor blade row 4 has a ring-shaped cover 6 connected to its outer circumferential side (i.e., the cover 6 is connected to the distal ends of the respective turbine blades). A main passage 7, through which steam (working fluid) flows, is made up of several passages including: the passages formed between an inner circumferential surface 8 of the casing 1 and an outer circumferential surface 9 of the endwall 5 (i.e., the passages between the stator vanes); and the passages formed between an inner circumferential surface 10 of the cover 6 and an outer circumferential surface 11 of the rotor 2 (i.e., the passages between the rotor blades). The steam, which is generated by a boiler or the like, is introduced into the main passage 7 of the steam turbine and flows in the direction shown by the arrow C₁ of FIG. 1.

The rotor blade row 4 is disposed downstream of the stator vane row 3 in terms of the rotor's axial direction (i.e., disposed on the right side of FIG. 1), and the pair of the stator vane row 3 and the rotor blade row 4 constitutes a stage. It should be noted that FIG. 1 illustrates only one stage for the sake of convenience, but in most cases, multiple stages are provided in the axial direction of the rotor to efficiently collect the internal energy of the steam. The stator vane row 3 converts the internal energy of the steam (pressure energy) into kinetic energy (velocity energy), and the rotor blade row 4 converts the kinetic energy of the steam into the rotational energy of the rotor 2. In other words, the steam acts on the rotor blades so as to rotate the rotor 2 about a central axis O.

A ring-shaped concave section 12 is formed on the inner circumferential surface 8 of the casing 1 in order to house the cover 6. For this reason, a narrow passage 15 is present between an outer circumferential surface 13 of the cover 6 and an opposing bottom surface 14 of the concave section 12, and a narrow inflow passage 18 lies between an upstream lateral surface 16 of the cover 6 and an opposing upstream lateral surface 17 of the concave section 12. A narrow outflow passage 21 is also located between a downstream lateral surface 19 of the cover 6 and an opposing downstream lateral surface 20 of the concave section 12. In such a turbine structure, while most of the steam flows through the main passage 7 to act on the rotor blades (i.e., flows through the spaces between the inner circumferential surface 10 of the cover 6 and the outer circumferential surface 11 of the rotor 2), part of it drifts away from the main passage 7 (i.e., escapes through the space downstream of the stator vane row 3 and upstream of the rotor blade row 4) as illustrated by the arrow C₂ of FIG. 2. Such escaping steam flows through the narrow inflow passage 18, the narrow passage 15, and the narrow outflow passage 21 and may fail to act on the turbine blades and to contribute to the rotation of the rotor 2. To prevent such steam leakage and thereby improve the turbine efficiency, a labyrinth seal is provided in the narrow passage 15. The labyrinth seal of the present embodiment includes a ring-shaped convex portion 22 and three rows of fins 23. The convex portion 22 is provided on the outer circumferential surface 13 of the cover 6 such that it is located at the center of the outer circumferential surface 13 in terms of the rotor's axial direction. The three fin rows 23 are provided on the bottom surface 14 of the concave section 12 such that the upstream row, the middle row, and the downstream row face part of the surface 13, the convex portion 22, and part of the surface 13, respectively. Of course, the arrangement and number of the convex portion 22 and the fins 23 are not limited to the above.

However, a limitation is placed on the seal space of the labyrinth seal (i.e., the distance between the fins 23 and the surfaces facing them) to cope with the deformation or displacement of components due to thermal expansion or thrust loads. Thus, even if a labyrinth seal is provided in the narrow passage 15, steam leakage from the main passage 7 to the narrow passage 15 is still likely to occur, which in turn causes unstable vibrations. Such being the case, we, the present inventors, conducted a fluid analysis to examine the hydrodynamic force components causing unstable vibrations (i.e., to examine the unstable hydrodynamic force already described with reference to FIG. 10). The following describes the method and the results.

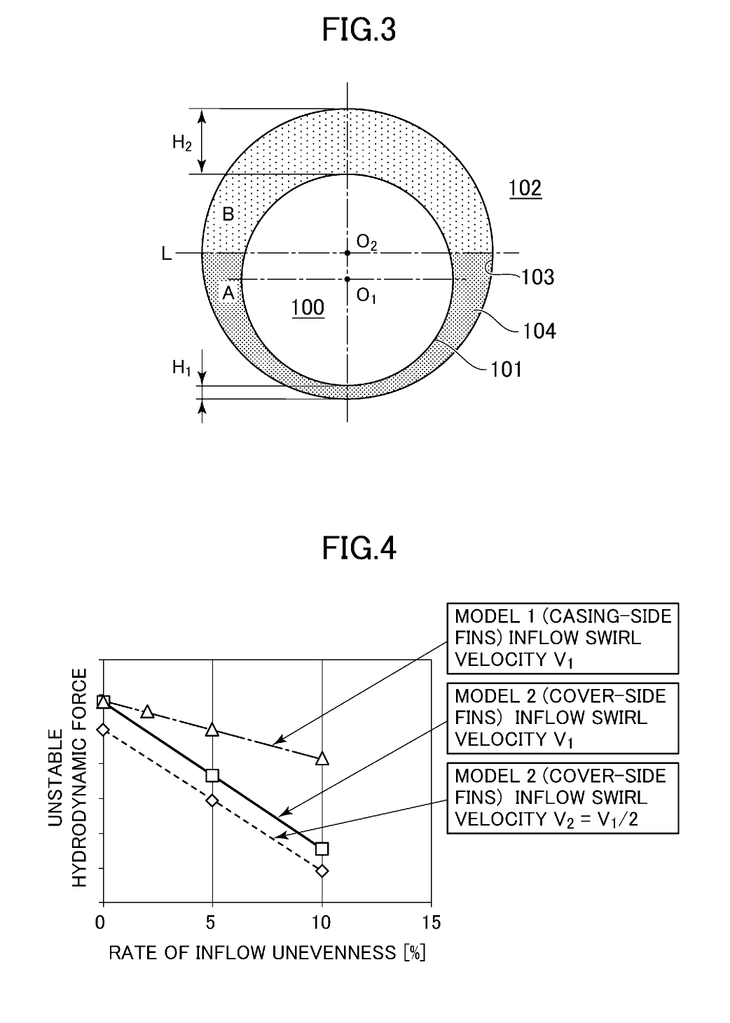

The model of FIG. 3 was used to conduct the analysis. In the model, a narrow passage 104 was formed between an outer circumferential surface 101 of a rotor 100 (corresponding to the outer circumferential surface 13 of the cover 6) and an inner circumferential surface 103 of a stator 102 (corresponding to the bottom surface 14 of the concave section 12). As illustrated in FIG. 3, the cross-sectional center O₂ of the rotor 100 deviates from the cross-sectional center O₂ of the stator 102. Thus, the width H of the narrow passage 104 varies depending on circumferential positions. Specifically, the width H₁ of the narrow passage 104 on the deviated side (i.e., the bottom side of FIG. 3) is relatively small while the width H₂ of the narrow passage 104 on the opposite side (i.e., the top side of FIG. 3) is relatively large. Further, the cross section A of the narrow passage 104 (i.e., the deviated-side cross section located below the center line L of the stator 102) is relatively small in area while the cross section B of the narrow passage 104 (i.e., the opposite-side cross section located above the center line L) is relatively large. Assume now that the total amount of the fluid flowing into the entire cross section of the narrow passage 104 is Q_{T}, that the amount of the fluid flowing into the deviated-side cross section A is Q_{A}, and that the amount of the fluid flowing into the opposite-side cross section B is Q_{B} (Q_{B}=Q_{T}−Q_{A}). As one of the analysis conditions, we varied the rate of inflow unevenness defined by the following formula (1) to conduct the fluid analysis. The inflow unevenness rate is zero when the inflow amounts Q_{B} and Q_{A} are equal. The larger the deviation of the inflow amount Q_{B}, from the inflow amount Q_{A}, the larger the inflow unevenness rate.

Rate of inflow unevenness [%]={Q_{B}×2/(Q_{A}+Q_{B})−1}×100 (1)

As another analysis condition, we also varied the inflow swirl velocity (i.e., the circumferential velocity of the fluid flowing into the narrow passage 104) between V₁ and V₂ (V₂=V₁/2). Moreover, the model of FIG. 3 was prepared in two forms to make a slight change to the narrow passage 104. In the first model, similar to the present embodiment (FIG. 2), fins were arranged on the stator 102 as a labyrinth seal (not illustrated). In the second model, fins were arranged on the rotor 100 as a labyrinth seal (not illustrated).

FIG. 4 is a graph illustrating the results of the fluid analysis (i.e., the relation between the inflow unevenness rate and the unstable hydrodynamic force). As illustrated in FIG. 4, the larger the inflow unevenness rate, the smaller the unstable hydrodynamic force. In other words, as the inflow amount Q_{B} becomes larger than the inflow amount Q_{A} in a manner proportional to the area difference between the opposite-side cross section B and the deviated-side cross section A, the unstable hydrodynamic force decreases accordingly. Similar results were also obtained when the labyrinth seal and the inflow swirl velocity were varied. This led us to conclude that the circumferential inflow distribution of the fluid flowing into the narrow passage had a significant influence on the unstable hydrodynamic force. The present invention has been made based on these new findings.

Referring back to FIGS. 1 and 2, the steam flowing through the stator vane row 3 has a relatively uniform flow rate distribution across the entire circumference of the stator vane row 3 though it has different flow rate distributions on a vane-by-vane basis. Thus, the steam entering the narrow inflow passage 18, too, has a relatively uniform flow rate distribution across the entire circumference of the narrow inflow passage 18. In the case of the conventional art shown in FIG. 5 where an expanded inflow passage 24, described later, is not present, since the virtual passage length upstream of the narrow passage 15 is relatively small, the steam entering the narrow passage 15 also has a relatively uniform flow rate distribution across the entire circumference of the narrow passage 15 (in other words, the inflow unevenness rate at the narrow passage 15 is small). Thus, in that case, the unstable hydrodynamic force is likely to become large when the rotor 2 becomes eccentric with respect to the casing 1 (i.e., when the width H of the narrow passage 15 varies in a circumferential direction).

Therefore, in the present embodiment, an expanded inflow passage 24 is provided between the narrow inflow passage 18 and the narrow passage 15 so that the virtual passage length upstream of the narrow passage 15 can become relatively large. The expanded inflow passage 24 has a substantially uniform structure in a circumferential direction and is formed such that it is located on the more outer side than the bottom surface 14 of the concave section 12 that constitutes the narrow passage 15 and such that it is located on the more upstream side in terms of the rotor's axial direction than the upstream lateral surface 17 of the concave section 12 that constitutes the narrow inflow passage 18.

The expanded inflow passage 24 includes wall surfaces 25a, 25b, 25c, and 25d. The wall surface 25a (outermost surface) is located on the more outer side than the bottom surface 14 of the concave section 12 and extends substantially parallel to the rotor's axial direction. The wall surface 25b (downstream lateral surface) connects the bottom surface 14 of the concave section 12 and the wall surface 25a and extends substantially parallel to the rotor's radial direction. The wall surface 25c (upstream lateral surface) is located on the more upstream side in terms of the rotor's axial direction than the upstream lateral surface 17 of the concave section 12 and extends substantially parallel to the rotor's radial direction. The wall surface 25d (innermost surface) connects the upstream lateral surface 17 of the concave section 12 and the wall surface 25c and extends slightly obliquely with respect to the rotor's axial direction.

The extended radial width Da of the expanded inflow passage 24 (i.e., the radial width between the bottom surface 14 of the concave section 12 and the wall surface 25a) and its extended axial width Db (i.e., the axial width between the upstream lateral surface 17 of the concave section 12 and the wall surface 25c) are both larger than the width H of the narrow passage 15 (i.e., the radial width between the outer circumferential surface 13 of the cover 6 and the bottom surface 14 of the concave section 12). Also, the extended radial width Da of the expanded inflow passage 24 is larger than the extended axial width Db.

In the present embodiment in which the expanded inflow passage 24 is provided, the virtual passage length upstream of the narrow passage 15 is larger than when the expanded inflow passage 24 is not present. When the expanded inflow passage 24 is not present, the direction of fluid flow can be represented by the arrow C₃ of FIG. 5. In contrast, when the expanded inflow passage 24 is present, the fluid flows in the form of a bypass flow as illustrated by the arrow C₄ of FIG. 2, which increases the virtual passage length.

As a first comparative example, assume that the expanded inflow passage 24 expands only toward the outer circumferential side from the bottom surface 14 of the concave section 12 (in other words, the extended axial width Db is zero). In this comparative example, even if the extended radial width Da is increased, a sufficient bypass flow cannot be produced, and the virtual passage length upstream of the narrow passage 15 cannot be extended either. As a second comparative example, assume that the expanded inflow passage 24 expands only toward the upstream side in terms of the rotor's axial direction from the upstream lateral surface 17 of the concave section 12 (in other words, the extended radial width Da is zero). In this comparative example as well, even if the extended axial width Db is increased, a sufficient bypass flow cannot be produced, and the virtual passage length upstream of the narrow passage 15 cannot be extended either. Also, the above comparative examples require consideration of the strength of the casing 1. In the present embodiment, by contrast, the expanded inflow passage 24 is formed such that it expands toward the outer circumferential side from the bottom surface 14 of the concave section 12 and toward the upstream side in terms of the rotor's axial direction from the upstream lateral surface 17 of the concave section 12. Thus, a sufficient bypass flow can be produced, and the virtual passage length upstream of the narrow passage 15 can also be extended. In addition, since the expanded inflow passage 24 has a substantially uniform structure in a circumferential direction, the flow of the fluid is not disturbed unlike in cases where circumferentially-spaced guide vanes or grooves are provided as in Patent Document 1.

Also, as stated already, the extended radial width Da and the extended axial width Db of the expanded inflow passage 24 are both larger than the width H of the narrow passage 15. Thus, a sufficient bypass flow can be produced, and the virtual passage length upstream of the narrow passage 15 can also be extended reliably. Further, since the extended radial width Da of the expanded inflow passage 24 is larger than the extended axial width Db, a bypass flow can be produced effectively. More specifically, the steam flowing through the stator vane row 3 and entering the narrow inflow passage 18 has swirl flow components and tends to flow radially outward due to the centrifugal force. Accordingly, to produce a bypass flow, it is more effective to increase the extended axial width Db than to increase the extended axial width Da.

Also, in the present embodiment, a projection 26 is provided on the upstream lateral surface 17 of the cover 6. With this projection 26, the steam entering the narrow inflow passage 18 is directed toward the upstream side in terms of the rotor's axial direction, thereby helping to develop a bypass flow. The axial position of a distal surface of the projection 26 overlaps the axial position of the expanded inflow passage 24. Specifically, the distal surface of the projection 26 is located axially upstream of the wall surface 25b constituting the expanded inflow passage 24 and of the bottom surface 14 constituting the narrow passage 15. With this structure, the steam flowing from the narrow inflow passage 18 is prevented from directly colliding with the bottom surface 14 of the concave section 12 and from directly flowing into the narrow passage 15. This in turn helps to develop a bypass flow in the expanded inflow passage 24.

As above, in the present embodiment, a bypass flow can be produced in the expanded inflow passage 24, and the virtual passage length upstream of the narrow passage 15 can be extended as well. These effects help to produce a deviation in the flow rate distribution of the steam entering the narrow passage 15 due to the deviations of the width H of the narrow passage 15. In other words, even if the steam entering the narrow inflow passage 18 has a uniform flow rate distribution, the steam is influenced by the deviations of the width H of the narrow passage 15 (i.e., the deviations of flow resistance) until it flows into the narrow passage 15. This produces a deviation in the flow rate distribution of the steam (in other words, the inflow unevenness rate at the narrow passage 15 can be increased). Accordingly, the unstable hydrodynamic force can be reduced effectively, which in turn prevents unstable vibrations.

Such advantageous effects achieved by the present embodiment are further described using the results of a fluid analysis. The analysis was conducted using two models: one with the expanded inflow passage 24 as in the present embodiment and one without the expanded inflow passage 24 as in the conventional art. Two fluid conditions were used at the entrance of the narrow inflow passage 18. In condition 1, the flow rate distribution of the fluid entering the narrow inflow passage 18 had a relatively small deviation while in condition 2, it had a relatively large deviation.

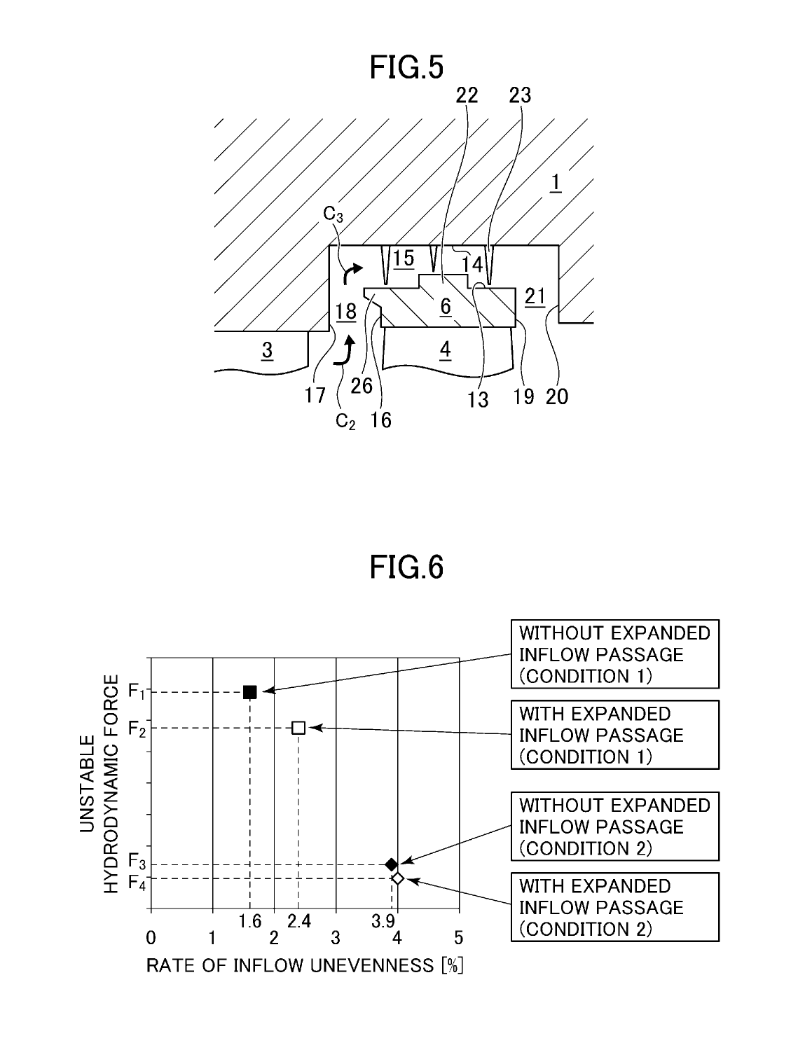

FIG. 6 is a graph illustrating the results of the fluid analysis (i.e., the inflow unevenness rate and the unstable hydrodynamic force at the narrow passage 15). In condition 1, when the expanded inflow passage 24 is not present, the inflow unevenness rate is 1.6%, and the unstable hydrodynamic force is F1. When the expanded inflow passage 24 is present under condition 1, the inflow unevenness rate increases up to 2.4%, the unstable hydrodynamic force decreases to F2 (decreases by about 17% of F1). In condition 2, when the expanded inflow passage 24 is not present, the inflow unevenness rate is 3.9%, and the unstable hydrodynamic force is F3. When the expanded inflow passage 24 is present under condition 2, the inflow unevenness rate increases up to 4.0%, the unstable hydrodynamic force decreases to F4 (decreases by about 30% of F3). The above analysis results, too, reveal that the presence of the expanded inflow passage 24 increases the inflow unevenness rate at the narrow passage 15, thereby reducing the unstable hydrodynamic force effectively.

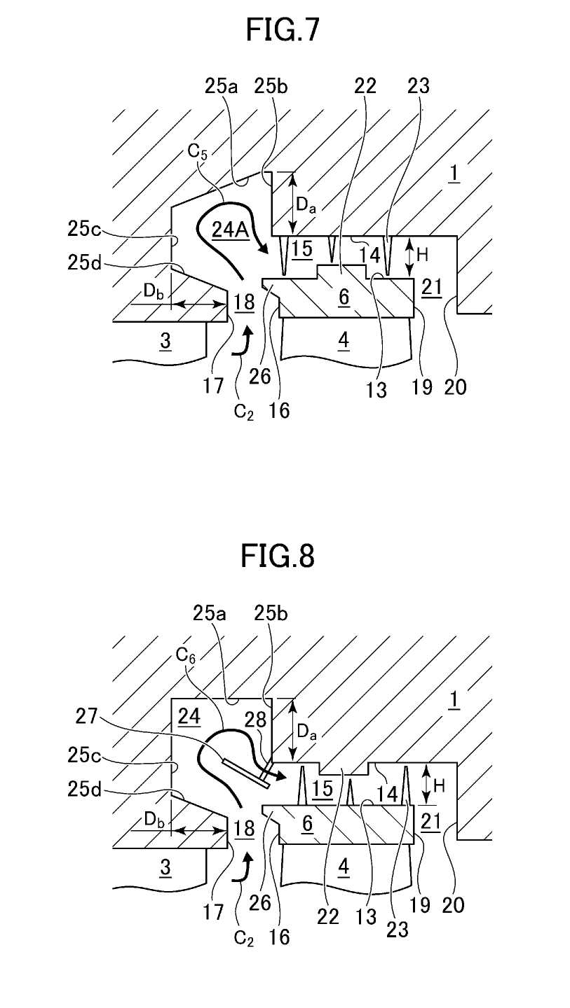

With reference now to FIG. 7, Embodiment 2 of the present invention is described. FIG. 7 is an enlarged cross section illustrating a concave section provided on the casing of a steam turbine according to Embodiment 2. The same components as used in Embodiment 1 are assigned the same reference numerals and will not be discussed further in detail.

In Embodiment 2, a wall surface 25a (radially outer surface) constituting an expanded inflow passage 24A is formed such that the axially downstream side of the wall surface 25a is tilted toward the outer circumferential side. In other words, the wall surface 25a is formed such that the diameter of the expanded inflow passage 24A increases in the axially downstream direction. This helps to develop a bypass flow as illustrated by the arrow C₅ of FIG. 7. More specifically, the steam flowing through the stator vane row 3 and entering the narrow inflow passage 18 has swirl flow components and flows radially outward due to the centrifugal force. The steam then collides with the wall surface 25a and is directed toward the axially downstream side, resulting in a bypass flow.

In Embodiment 2, the tilted wall surface 25a further promotes a bypass flow in the expanded inflow passage 24A compared with Embodiment 1, and the virtual passage length upstream of the narrow passage 15 can be extended as well. This increases the inflow unevenness rate at the narrow passage 15 and further reduces the unstable hydrodynamic force to prevent unstable vibrations.

In Embodiments 1 and 2, as a labyrinth seal, the convex portion 22 is formed on the outer circumferential surface 13 of the cover 6, and the multiple rows of fins 23 are provided on the bottom surface 14 of the concave section 12 so as to face the convex portion 22 and the outer circumferential surface 13. However, the structure of the labyrinth seal is not limited to the above, but can be modified in various forms without departing from the scope and spirit of the invention. For example, the convex portion 22 can instead be formed on the bottom surface 14 of the concave section 12, and the fins 23 can instead be provided on the outer circumferential surface 13 of the cover 6 so as to face the convex portion 22 and the bottom surface 14. Further, the convex portion 22 need not necessarily be provided either on the outer circumferential surface 13 of the cover 6 or on the bottom surface 14 of the concave section 12. Moreover, fins 23 can be provided both on the bottom surface 14 of the concave section 12 and on the outer circumferential surface 13 of the cover 6. In any of those modifications, similar advantageous effects can be achieved.

Also, for the purpose of promoting a bypass flow in the expanded inflow passage 24, the projection 26 of Embodiments 1 and 2 is provided on the upstream lateral surface 16 of the cover 6 such that the axial position of the distal surface of the projection 26 overlaps the axial position of the expanded inflow passage 24. However, the structure of the projection 26 is not limited to the above, but can be modified in various forms without departing from the scope and spirit of the invention. For example, the distal surface of the projection 26 can instead be located axially downstream of the expanded inflow passage 24 though the virtual passage length decreases slightly. Further, the projection 26 need not necessarily be provided on the upstream lateral surface 16 of the cover 6. In that case, the axial position of the upstream lateral surface 26 of the cover 6 should preferably overlap the axial position of the expanded inflow passage 24, but the upstream lateral surface 16 can also be located axially downstream of the expanded inflow passage 24. In any of those modifications, the unstable hydrodynamic force induced by leakage flow can be reduced, which in turn prevents unstable vibrations.

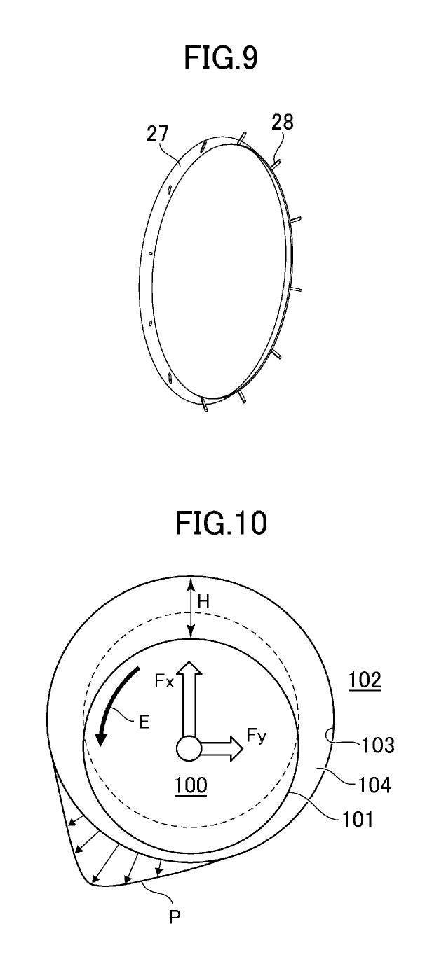

Referring now to FIGS. 8 and 9, Embodiment 3 of the present invention is described. FIG. 8 is an enlarged cross section illustrating a concave section provided on the casing of a steam turbine according to Embodiment 3. FIG. 9 is a perspective view illustrating the whole structure of a bypass member having support members. The same components as used in Embodiment 1 are assigned the same reference numerals and will not be discussed further in detail.

In Embodiment 3, a ring-shaped bypass member 27 is disposed in the expanded inflow passage 24. The bypass member 27 is shaped like a hollow circular truncated cone and is formed such that the axially upstream side of an axial cross section of the bypass member 27 is tilted toward the outer circumferential side. Multiple bar-shaped support members 28 are provided on the outer circumferential surface of the bypass member 27 such that the support members 28 are spaced circumferentially. These support members 28 are used to attach the bypass member 27 to the casing 1. The bypass member 27 helps develop a bypass flow as illustrated by the arrow C₆ of FIG. 8. More specifically, the steam flowing through the stator vane row 3 and entering the narrow inflow passage 18 has swirl flow components and tends to flow radially outward due to the centrifugal force. After colliding with the inner circumferential surface of the bypass member 27, the steam is directed toward the axially upstream side. The steam then flows through the space between the inner circumferential surface of the bypass member 27 and the wall surface 25d toward the axially upstream side. Thereafter, the steam flows through the space between the outer circumferential surface of the bypass member 27 and the wall surface 25b toward the axially downstream side. Thus, the steam flows in the form of a bypass flow.

In Embodiment 3 as well, the projection 26 is provided on the upstream lateral surface 17 of the cover 6. With this projection 26, the steam entering the narrow inflow passage 18 is directed toward the upstream side in terms of the rotor's axial direction, thereby helping to develop a bypass flow. The axial position of a distal surface of the projection 26 overlaps the axial position of the expanded inflow passage 24. The distal surface of the projection 26 is also located axially upstream of the axially downstream edge of the bypass member 27. This prevents the steam from directly flowing from the narrow inflow passage 18 to the narrow passage 15 and helps promote a bypass flow in the expanded inflow passage 24.

The bypass member 27 can be made up of either a single unit or multiple circumferentially divided units. The bypass member 27, the support members 28, and the casing 1 are interconnected by welding or bolts, but the connection method is not limited thereto.

In Embodiment 3, as a labyrinth seal, the convex portion 22 is formed on the bottom surface 14 of the concave section 12, and the three rows of fins 23 are provided on the outer circumferential surface 13 of the cover 6 so as to face the bottom surface 14 and the convex portion 22. Of course, the arrangement and number of the convex portion 22 and the fins 23 are not limited to the above. In light of possible deformation or displacement of components due to thermal expansion or thrust loads, the space between the bypass member 27 and the most upstream row of fins 23 should preferably be equal to or greater than the width H of the narrow passage 15.

In Embodiment 3, the presence of the bypass member 27 further promotes a bypass flow in the expanded inflow passage 24A compared with Embodiment 1, and the virtual passage length upstream of the narrow passage 15 can be extended as well. This increases the inflow unevenness rate at the narrow passage 15 and further reduces the unstable hydrodynamic force to prevent unstable vibrations.

As already stated, as the labyrinth seal of Embodiment 3, the convex portion 22 is formed on the bottom surface 14 of the concave section 12, and the multiple rows of fins 23 are provided on the outer circumferential surface 13 of the cover 6 so as to face the bottom surface 14 and the convex portion 22. However, the structure of the labyrinth seal is not limited to the above, but can be modified in various forms without departing from the scope and spirit of the invention. For example, the convex portion 22 can instead be formed on the outer circumferential surface 13 of the cover 6, and the fins 23 can instead be provided on the bottom surface 14 of the concave section 12 so as to face the outer circumferential surface 13 and the convex portion 22. Further, the convex portion 22 need not necessarily be provided either on the outer circumferential surface 13 of the cover 6 or on the bottom surface 14 of the concave section 12. Moreover, fins 23 can be provided both on the bottom surface 14 of the concave section 12 and on the outer circumferential surface 13 of the cover 6. In any of those modifications, similar advantageous effects can be achieved.

Also, for the purpose of promoting a bypass flow in the expanded inflow passage 24, the projection 26 of Embodiment 3 is provided on the upstream lateral surface 16 of the cover 6 such that the axial position of the distal surface of the projection 26 overlaps the axial position of the expanded inflow passage 24 and such that the distal surface of the projection 26 is located axially upstream of the axially downstream edge of the bypass member 27. However, the structure of the projection 26 is not limited to the above, but can be modified in various forms without departing from the scope and spirit of the invention. For example, the distal surface of the projection 26 can instead be located axially downstream of the expanded inflow passage 24 though the virtual passage length decreases slightly. Also, the distal surface of the projection 26 can instead be located axially downstream of the axially downstream edge of the bypass member 27. Further, the projection 26 need not necessarily be provided on the upstream lateral surface 16 of the cover 6. In that case, the axial position of the upstream lateral surface 26 of the cover 6 should preferably overlap the axial position of the expanded inflow passage 24, and the upstream lateral surface 16 of the cover 6 should preferably be located axially upstream of the axially downstream edge of the bypass member 27. However, the upstream lateral surface 26 of the cover 6 can also be located axially downstream of the expanded inflow passage 24 and of the axially downstream edge of the bypass member 27. In any of those modifications, the unstable hydrodynamic force induced by leakage flow can be reduced, which in turn prevents unstable vibrations.

While the foregoing description is based on the assumption that the invention is applied to a steam turbine, one type of axial flow turbine, the application of the invention is not limited thereto. For instance, the invention can also be applied to gas turbines, axial flow compressors, and the like. In either case, similar advantageous effects can be achieved.

### DESCRIPTION OF REFERENCE NUMERALS

1: Casing
2: Rotor
3: Stator vane row
4: Rotor blade row
6: Cover
8: Inner circumferential surface of casing
12: Concave section
13: Outer circumferential surface of cover
14: Bottom surface of concave section
15: Narrow passage
16: Upstream lateral surface of cover
17: Upstream lateral surface of concave section
18: Narrow inflow passage
19: Downstream lateral surface of cover
20: Downstream lateral surface of concave section
21: Narrow outflow passage
22: Convex portion
23: Fin
24, 24A: Expanded inflow passage
25a, 25b, 25c, 25d: Wall surface
26: Projection
27: Bypass member

1. An axial flow machine comprising:
a casing;
a rotor rotatably provided within the casing;
a stator vane row provided on the inner circumferential side of the casing;
a rotor blade row provided on the outer circumferential side of the rotor and located downstream side in terms of the rotor's axial direction with respect to the stator vane row;
a ring-shaped cover connected to the outer circumferential side of the rotor blade row;
a ring-shaped concave section provided on an inner circumferential surface of the casing for housing the cover;
a narrow passage formed between an outer circumferential surface of the cover and a bottom surface of the concave section, the narrow passage having a labyrinth seal disposed therein;
a narrow inflow passage formed between an upstream lateral surface of the cover and an upstream lateral surface of the concave section; and
a narrow outflow passage formed between a downstream lateral surface of the cover and a downstream lateral surface of the concave section,
wherein the axial flow machine further comprises an expanded inflow passage formed between the narrow inflow passage and the narrow passage, and
wherein the expanded inflow passage is configured to:
have a substantially uniform structure in a circumferential direction;
be located on the more outer circumferential side than the bottom surface of the concave section constituting the narrow passage; and
be located upstream side in terms of the rotor's axial direction with respect to the upstream lateral surface of the concave section constituting the narrow inflow passage.

2. The axial flow machine of claim 1, wherein an extended radial width Da of the expanded inflow passage that extends from the bottom surface of the concave section constituting the narrow passage is larger than a width H of the narrow passage that extends from the outer circumferential surface of the cover to the bottom surface of the concave section.

3. The axial flow machine of claim 1 wherein an extended axial width Db of the expanded inflow passage that extends from the upstream lateral surface of the concave section constituting the narrow inflow passage is larger than a width H of the narrow passage that extends from the outer circumferential surface of the cover to the bottom surface of the concave section.

4. The axial flow machine of claim 1 wherein a projection is provided on the upstream lateral surface of the cover.

5. The axial flow machine of claim 4 wherein the projection has a distal surface located at a position overlaps the position of the expanded inflow passage in terms of the rotor's axial direction.

6. The axial flow machine of claim 1 wherein a wall surface of the expanded inflow passage located on the more outer circumferential side than the bottom surface of the concave section constituting the narrow passage is formed such that the wall surface is tilted toward the outer circumferential side in the rotor's axial downstream direction.

7. The axial flow machine of claim 1 further comprising a ring-shaped bypass member located within the expanded inflow passage for promoting a bypass flow in the expanded inflow passage.

8. The axial flow machine of claim 7 wherein the bypass member has a hollow circular truncated cone shape and is formed such that the bypass member is tilted toward the outer circumferential side in the rotor's axial upstream direction.

9. The axial flow machine of claim 7,
wherein a projection is provided on the upstream lateral surface of the cover,
wherein the projection has a distal surface configured to:
be located at a position overlaps the position of the expanded inflow passage in terms of the rotor's axial direction; and
be located at a position upstream with respect to a downstream edge of the bypass member in terms of the rotor's axial direction.
